(19) United States
(12) Patent Application Publication
(10) Pub. No.: US 2010/0325000 A1
(43) Pub. Date: Dec. 23, 2010

(54) ORDERING METHOD AND ORDER MANAGEMENT SYSTEM

(75) Inventor: Kazuharu Teraoka, Tokyo (JP)

Correspondence Address: K&L Gates LLP, P.O. Box 1135, CHICAGO, IL, 60690, US

(73) Assignee: TERAOKA SEIKO CO., LTD., Tokyo (JP)

(21) Appl. No.: 12/817,836

(22) Filed: Jun. 17, 2010

(30) Foreign Application Priority Data
Jun. 18, 2009 (JP) P2009-145250

(51) Int. Cl. G06Q 50/00; G06Q 10/00

(52) U.S. Cl. 705/15

(57) ABSTRACT

An order management system includes a pen-shaped scanner a1n (n=1 to N) for reading codes indicating items from a menu to obtain order information, the menu having a plurality of codes indicating items recorded thereon; a printer/cradle a1n for issuing an exchange coupon having identification information printed thereon, the identification information identifying the order information obtained by the pen-shaped scanner a1n; and a register c1 for performing a settlement process based on the exchange coupon when the items indicated by the order information are delivered. Further, a plurality of sets of the pen-shaped scanner a1n (n=1 to N) and the printer/cradle a1n are included adjacent to one another toward customers.

### CROSS REFERENCES TO RELATED APPLICATIONS

This application claims priority to Japanese Patent Application No. 2009-145250 filed on Jun. 18, 2009, the disclosure of which is incorporated herein by reference.

### BACKGROUND

The present disclosure relates to an ordering method and an order management system.

In a conventional art, items are ordered and settled for their price at fast food stores such as hamburger chain stores, as follows. First, a customer determines items to be ordered while viewing a menu list before a register. An employee then listens to an order from the customer and inputs the order to the register for settlement of prices. Then, an employee performs cooking based on the order. Finally, the employee delivers the cooked items to the customer.

The following schemes have been introduced in fast food stores.

For example, an electronic cash register system including a display controller connected with an electronic cash register via a first communication line, a monitor connected to the display controller, and a printer connected with the electronic cash register via a second communication line is described in Japanese Patent Application, First Publication No. 2003-85648. The electronic cash register transmits registered items information to the monitor via the display controller to display the information or transmits the information to the printer to print the information.

However, customers often stand in a long waiting line to order items, particularly during meal time at fast food stores. This is primarily because it takes a long time for customers to order items and an employee must wait during that time. Further, since the total amount of money is not determined until an order is input, settlement process cannot be performed. As a result, the total processing time is long. To resolve the issue of standing in a long line, it is necessary to increase the number of employees and registers and improve the processing capability for order input.

However, registers are expensive and increasing employees causes increased expenses for personal. That is, an increase of employees and registers is impractical due to high cost.

Therefore, it is desired to provide an ordering method and an order management system capable of shortening the line at fast food stores without increasing the number of employees or registers.

### SUMMARY

To resolve the aforementioned problems and achieve the object, the present invention employs the following.

An ordering method capable of receiving an input of order information for items and performing a settlement process when the items indicated by the order information that have been cooked are delivered. The ordering method uses an order management system including an order input unit for reading codes indicating items from a menu to obtain the order information, the menu having a plurality of codes indicating items recorded thereon; an exchange coupon printing unit for issuing an exchange coupon having identification information printed thereon, the identification information identifying the order information obtained by the order input unit; and a settlement processor for performing the settlement process based on the exchange coupon when the items indicated by the order information are delivered, wherein a plurality of sets of the order input unit and the exchange coupon printing unit are disposed adjacent to one another toward customers. The ordering method includes an order input step of reading, by the order input unit, the codes chosen by the customer to obtain the order information; an exchange coupon printing step of issuing, by the exchange coupon printing unit, an exchange coupon to the customer, the exchange coupon having identification information for the order information obtained in the order input step printed thereon; and a settlement processing step of performing, by the settlement processor, the settlement process based on the exchange coupon when the items indicated by the order information are delivered.

An order management system according to an embodiment for receiving an input of order information for items and performing a settlement process when the items indicated by the order information that have been cooked are delivered includes an order input unit for reading codes indicating items from a menu to obtain the order information, the menu having a plurality of codes indicating items recorded thereon; an exchange coupon printing unit for issuing an exchange coupon having identification information printed thereon, the identification information identifying the order information obtained by the order input unit; and a settlement processor for performing the settlement process based on the exchange coupon when the items indicated by the order information are delivered, wherein a plurality of sets of the order input unit and the exchange coupon printing unit are disposed adjacent to one another in front of customers.

In the order management system, an order completion code indicating that all orders have been completed may be recorded on the menu, and when the order input unit reads the order completion code from the menu, the exchange coupon printing unit may issue the exchange coupon.

In the order management system, a counter may be provided between a kitchen area where an employee cooks items and a customer area, a plurality of sets of the order input unit and the exchange coupon printing unit may be disposed on the counter, and the customer may input the order information using the order input unit.

According to the present invention, since a configuration for inputting an order includes the menu, the order input unit for reading the menu code and inputting order data, and the exchange coupon printing unit, the system does not have keys or drawers, has a small size, and is inexpensive, in comparison with a register. Also, order input does not require an employee. As a result, simultaneous order inputs by a greater number of customers can be realized without causing high cost, thereby shortening a waiting line for an order.

According to the embodiment, since an order device and a settlement device at a fast food store are separated, it is possible to efficiently use the settlement device. Also, as an order does not take time and effort, it is possible to improve customer service provided by employees.

According to the embodiment, since the exchange coupon printing unit issues the exchange coupon when the order input unit reads the order completion code from the menu, it is unnecessary to provide a key for instructing to issue the exchange coupon to the order input unit or the exchange coupon printing unit. Also, since the codes indicating items and the order completion code are recorded on the menu, an operation can be easily performed, in comparison with a case in which items designation keys and an order completion key are provided separately.

According to the embodiment, since a set of the order input unit and the exchange coupon printing unit is disposed on a counter between a kitchen area and a customer area, a distance between a customer operating the order input unit and the employee can be shorter. Accordingly, the customer can freely ask the employee for assistance, and even when the customer does not know how to operate and erroneously inputs an order, unnecessary troubles, such as order cancellation after cooking completion, can be prevented.

Additional features and advantages are described herein, and will be apparent from the following Detailed Description and the figures.

### BRIEF DESCRIPTION OF THE FIGURES

FIG. 1 is a schematic block diagram showing an order management system of embodiment.

FIG. 2 is a schematic view showing a layout of a store according to the embodiment.

FIG. 3 is a schematic view showing a plurality of order input sets according to the embodiment.

FIG. 4 is an electrical block diagram showing an internal configuration of a pen-shaped scanner according to the embodiment.

FIG. 5 is an electrical block diagram showing an internal configuration of a printer/cradle according to the embodiment.

FIG. 6 is a schematic view showing an example of a menu according to the embodiment.

FIG. 7 is a schematic view showing an example of an exchange coupon according to the embodiment.

FIG. 8 is a schematic diagram showing an example of a menu file according to the embodiment.

FIG. 9 is a schematic diagram showing an example of an order file according to the present exemplary embodiment.

FIG. 10 is a flowchart showing an operation of an order management system according to the present exemplary embodiment.

### DETAILED DESCRIPTION

### Exemplary Embodiment

Hereinafter, embodiments for carrying out an order management will be described.

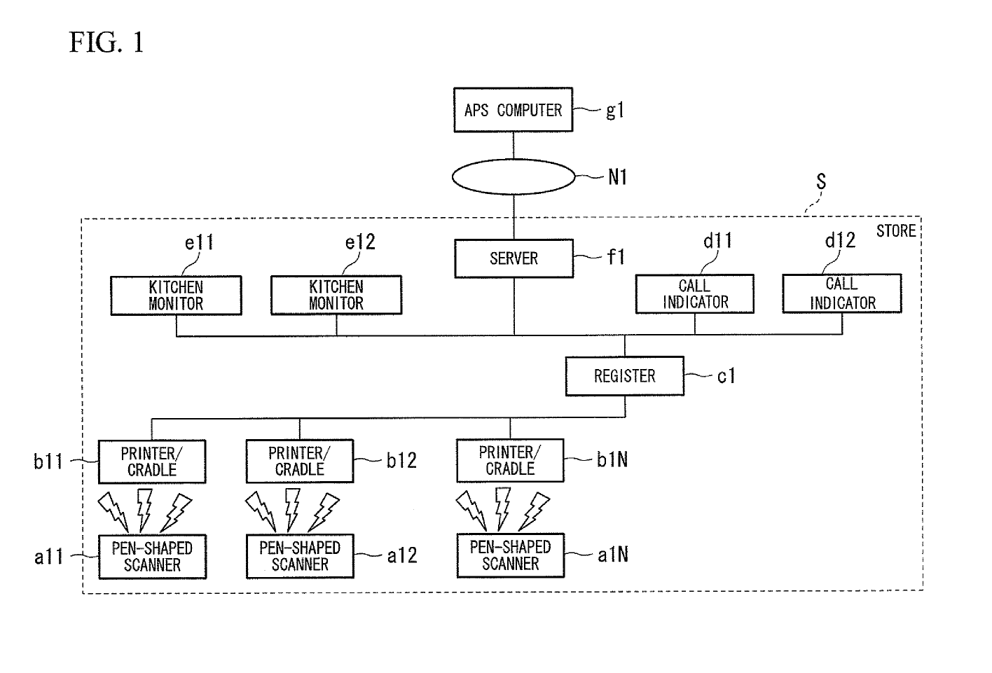

FIG. 1 is a schematic block diagram showing an order management system of the embodiment.

In FIG. 1, an order management system includes ASP (an application service provider) computer g1 connected with a server f1 in a store S via a network N1, such as the Internet. The ASP computer g1 is used to manage information of a chain store (the store S in the present embodiment) in an integrated manner. The order management system includes, in the store S, pen-shaped scanners a1n (n is a natural number ranging from 1 to N), printer/cradles b1n (n is a natural number ranging from 1 to N), a register c1, call indicators d11 and d12, kitchen monitors e11 and e12, and the server f1.

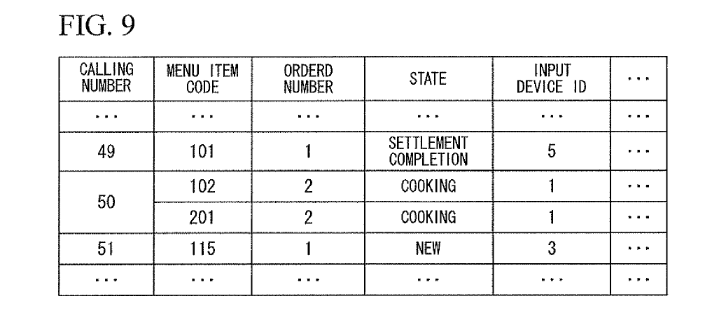

In FIG. 1, the server f1 is a computer for processing order information (see FIG. 9) indicating order content from customers and storing, for example, various files (e.g., a menu file) as a database. For example, the server f1 is disposed in an office of a restaurant. The server f1 has a communication function using a wired LAN (local area network). The server f1 is communicatively connected with the register c1, the call indicators d11 and d12, and the kitchen monitors e11 and e12 via the wired LAN in the store S.

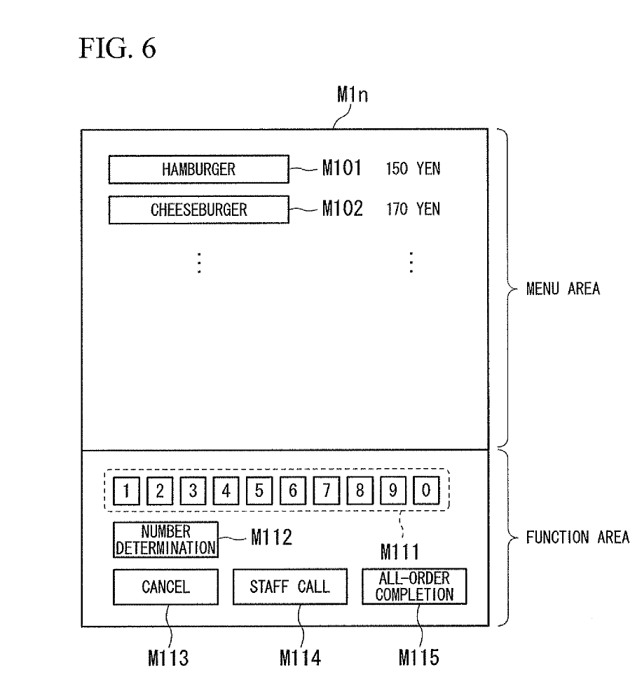

In FIG. 1, the pen-shaped scanner a1n (order input unit) reads codes from a menu M1n (FIG. 6) having a plurality of menu item codes indicating items and a plurality of function codes for controlling order input recorded thereon, to obtain order information. The pen-shaped scanner a1n can wirelessly communicate with the register c1.

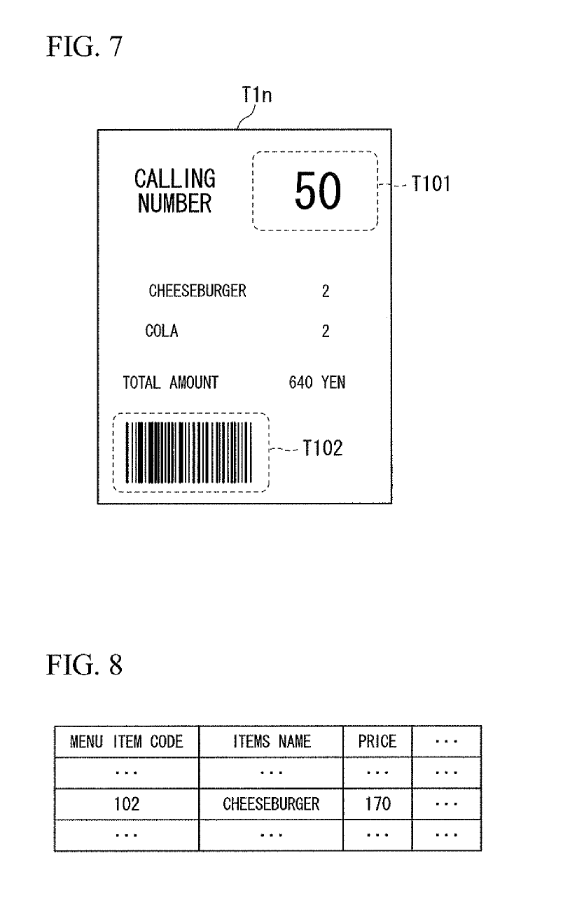

In FIG. 1, the printer/cradle b1n (exchange coupon printing unit) issues an exchange coupon T1n (FIG. 7) on which a calling number for identifying the order information obtained by the pen-shaped scanner a1n is printed. The printer/cradle b1n is communicatively connected to the register c1 using a USB (universal serial bus) cable. The printer/cradle b1n has a mount opening for mounting the pen-shaped scanner a1n. For example, when the pen-shaped scanner a1n that is not used is mounted on the mount opening, the printer/cradle b1n charges the pen-shaped scanner a1n.

In FIG. 1, the register c1 (settlement processor) performs a settlement process based on the exchange coupon T1n when items indicated by the order information are delivered. The register c1 has a USB communication function and a wireless communication function.

In FIG. 1, when an employee inputs a calling number from the register c1, the call indicators d11 and d12 indicate the calling number.

In FIG. 1, when the printer/cradle b1n issues the exchange coupon T1n, the kitchen monitors e11 and e12 display the order information.

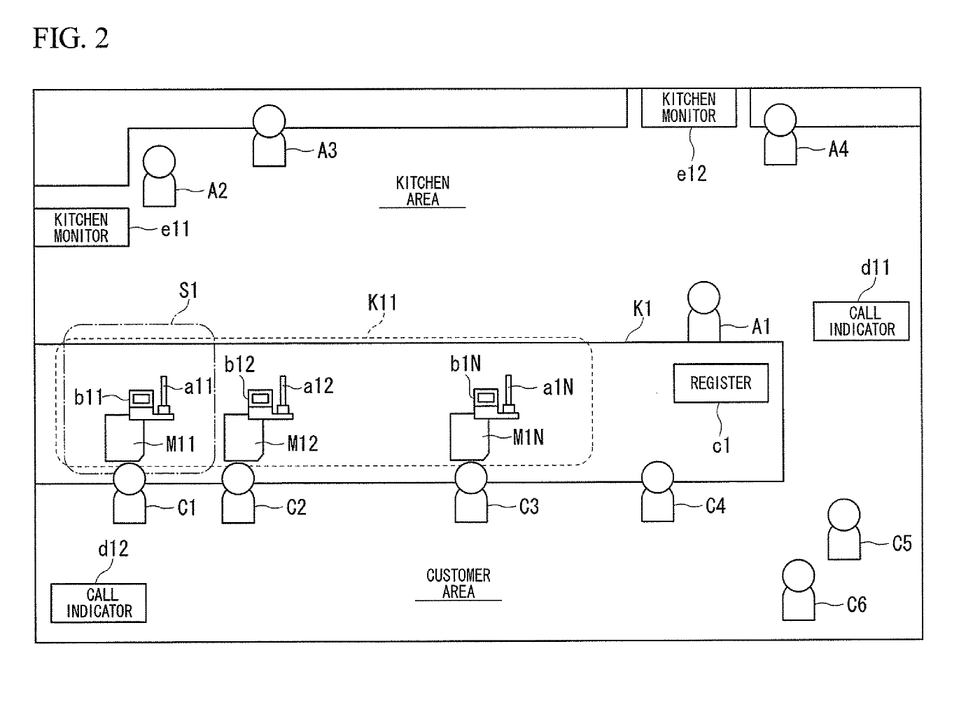

FIG. 2 is a schematic view showing a layout of the store S according to the present embodiment.

In FIG. 2, a counter K1 is provided between a kitchen area where employees A1 to A4 cook items and a customer-side area where a customer inputs order information using the pen-shaped scanner a1n or waits to receive the items in the store S.

In FIG. 2, a menu M1n, a pen-shaped scanner a1n, and a printer/cradle b1n constitute an order input set Sn used for the customer to input the order information. For example, the menu M11, the pen-shaped scanner a11, and the printer/cradle b11 surrounded by a dashed dotted line indicated by reference number S1 constitute one order set. In the present embodiment, one menu M1n, one pen-shaped scanner a1n, and one printer/cradle b1n constitute one order input set. However, the present invention is not limited thereto. For example, one order input set may include a plurality of menus or a plurality of pen-shaped scanners.

In FIG. 2, a plurality of order input sets S1 to Sn are disposed in an area surrounded by a dotted line indicated by reference numeral K11 in a counter K1 and one register c1 is disposed near the area K11. The order input sets S1 to Sn with which the customer inputs an order and the register c1 with which a items settlement process is performed are in different cases. Also, there are more of the order input sets S1 to Sn than the registers c1. According to the layout as shown in FIG. 2, customers C1 to C6 and the employees A1 to A4 are located closer to one another. Accordingly, if the customer does not know well how to input using the order input sets S1 to Sn, the customer can easily ask the employee. Even when the customer does not know how to operate the resister and erroneously inputs an order, unnecessary troubles, such as order cancellation after cooking completion, can be prevented.

In FIG. 2, kitchen monitors e11 and e12 are large monitors (e.g., 26-inch LCD monitors), which are disposed at a high position near a ceiling so that the employees A1 to A6 in the kitchen area can readily view displayed content.

In FIG. 2, call indicators d11 and d12 are large monitors (e.g., 26-inch LCD monitors), which are disposed at a high position near a ceiling so that the customers C1 to C6 in the customer-side area can readily view displayed content.

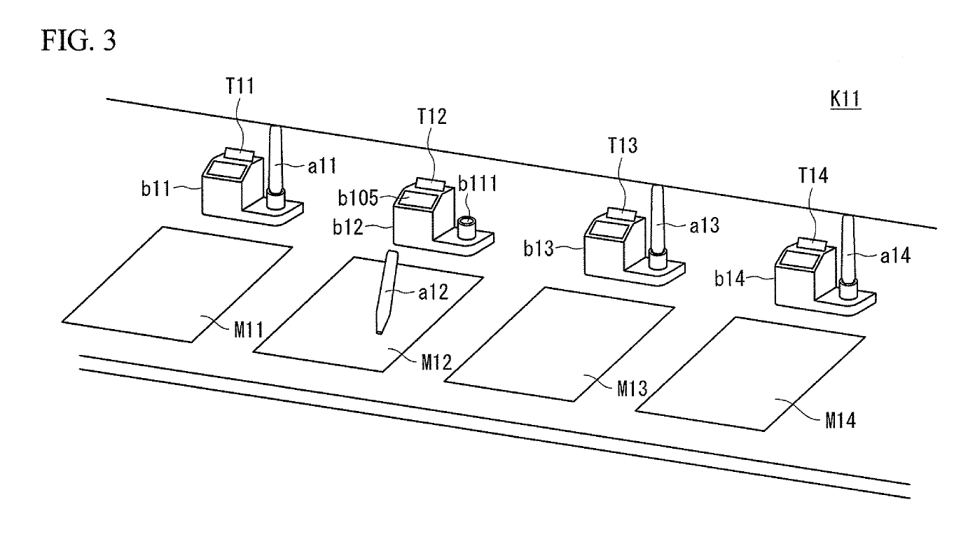

FIG. 3 is a schematic view showing the plurality of order input sets Sn according to the present embodiment. FIG. 3 is an enlarged view of the area K11 in FIG. 2, in which four order input sets Sn (n=1, 2, 3, 4) are shown.

In FIG. 3, a mount opening for the pen-shaped scanner a1n is provided in the printer/cradle b1n. For example, the pen-shaped scanner a11 is mounted on the mount opening of the printer/cradle b11, as shown. Meanwhile, the pen-shaped scanner a12 is being used and is not mounted on a mount opening b111 of the printer/cradle b12. For example, when a customer uses the order input set S2 (a menu M12, the pen-shaped scanner a12, and the printer/cradle b12), the customer chooses items recorded on the menu M12 and reads a menu item code in an area in which name of the items is recorded, using the pen-shaped scanner a12. Further, the printer/cradle b1n includes a display unit (e.g., a display unit b105 for the printer/cradle b12). Also, an outlet for the printed exchange coupon T1n is provided in an upper portion of the printer/cradle b1n.

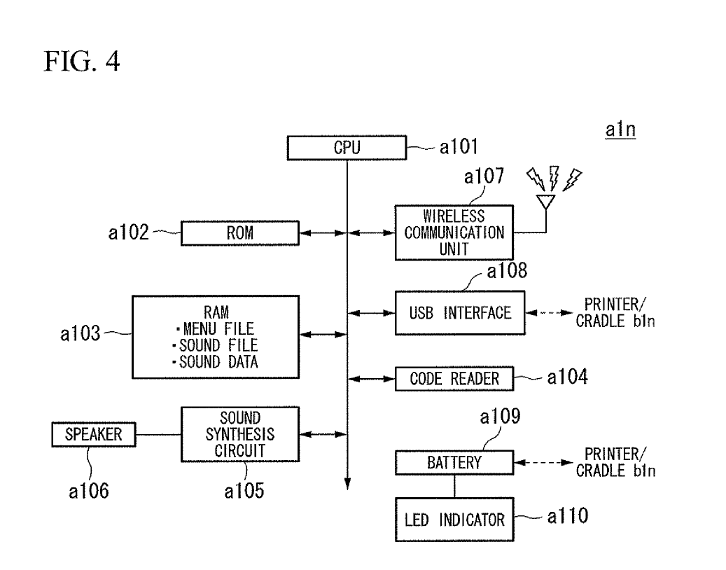

FIG. 4 is an electrical block diagram showing an internal configuration of the pen-shaped scanner a1n according to the present embodiment.

In FIG. 4, a CPU a101 is a central processing unit for controlling respective components of the pen-shaped scanner a1n, and loads and executes a predetermined program from a ROM (read only memory) a102. The ROM a102 is a storage unit for storing various programs, which are executed by the CPU a101. A random access memory (RAM) a103 is a storage unit having a file storage area in which a menu file (FIG. 7) or sound file, sound data, or the like are stored.

In FIG. 4, a code reader a104 is an infrared reading unit for reading various codes, such as the menu item codes or the function codes, printed on the menu M1n using an infrared light. The code reader a104 is provided at a pen tip of the pen-shaped scanner a1n. The code printed on the area in the menu M1n is input by putting the code reader a104 on the area or scanning the area.

In FIG. 4, a sound synthesis circuit a105 is a digital circuit for synthesizing sound waveforms from sound data of the sound file read from the RAM a103 and outputting a resultant signal to a speaker a106. Sound data relating to a menu input from the code reader a104 is sound-output by the sound synthesis circuit a105, and sound is generated as guide information for the menu from the speaker a106.

In FIG. 4, a wireless communication unit a107 is a ZigBee (registered trademark)-based communication device that wirelessly communicates order data with the register c1.

In FIG. 4, a USB interface a108 is a communication interface that is connected to a USB connector provided inside the mount opening b111 when the pen-shaped scanner is mounted to the printer/cradle b1n, and performs communication for updating the sound data in the RAM a103.

In FIG. 4, a battery a109 is a rechargeable built-in battery for supplying power to respective components of the pen-shaped scanner a1n, and is charged when the pen-shaped scanner a1n is mounted on the printer/cradle b1n. the remaining amount of the battery a109 is indicated by a LED indicator a110.

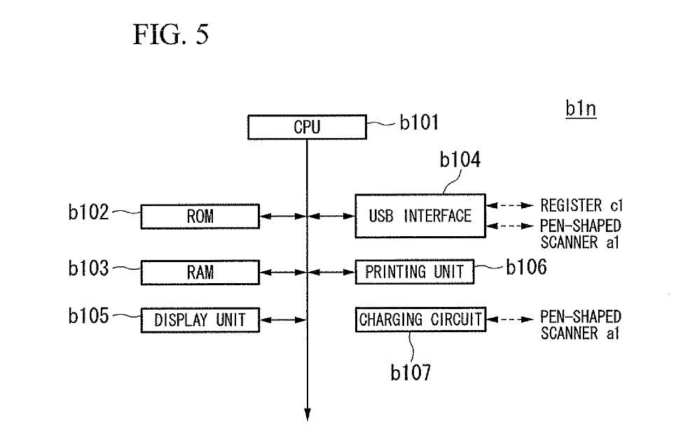

FIG. 5 is an electrical block diagram showing an internal configuration of the printer/cradle b1n according to the present embodiment.

In FIG. 5, a CPU b101 is a central processing unit for controlling respective components of the printer/cradle b1n and loading and executing a predetermined program from a ROM b102. The ROM b102 is a storage unit (read only memory) for storing various programs, which are executed by the CPU b101. A RAM b103 is a storage unit (random access memory) for temporarily storing data called and used by the CPU b101 in operation.

In FIG. 5, a USB interface b104 is a communication interface that is connected to a USB connector provided inside the mount opening b111 when the pen-shaped scanner a1n is mounted, and performs communication for updating information stored in the pen-shaped scanner a1n. The USB interface b104 is a communication interface that communicates with the register c1. For example, the USB interface b104 receives order information, which will be described below, and information of a calling number bar code obtained by coding a calling number from the server f1 via the register c1.

In FIG. 5, a display unit b105 displays the order information received by the USB interface b104. For example, when the customer reads a new menu item code using the pen-shaped scanner a1n, the display unit b105 additionally displays name of items corresponding to the read menu item code.

In FIG. 5, a printing unit b106 prints the order information and the calling number bar code information on an exchange coupon T1n, which is output from the outlet.

A charging circuit b107 supplies power to the mounted pen-shaped scanner a1n.

FIG. 6 is a schematic view showing an example of the menu M1n according to the present embodiment. The menu M1n shown in FIG. 6 is obtained by printing content to be recorded on a thick paper and coating a surface of the paper.

In FIG. 6, items names and prices of various items are recorded in a menu area of the menu M1n. For example, a “hamburger” is recorded as the items name and “150” Yen as the price thereof in an area M101.

In FIG. 6, numerals and function names are recorded in a function area of the menu M1n. For example, numerals “0” to “9” are recorded in an area surrounded by a dotted line M111. Function names “Number determination,” “Cancel,” “Staff call” and “all-order completion” are recorded in areas M112 to M115. The menu item codes and the function codes are recorded in the areas M101, M102, . . . , and M111 to M115 by an invisible marking scheme (e.g., 3D code). The codes can be read by the pen-shaped scanner a1n. For example, when the pen tip (code reader 204) of the pen-shaped scanner a1n is put on the area M101, the menu item code indicating a hamburger is read. For example, when the pen tip of the pen-shaped scanner a1n is put on an area in the area M111 having numeral “2” recorded thereon is written, numeral “2” is input. For example, when the pen tip of the pen-shaped scanner a1n is put on the area M115, the all-order completion code indicating that all orders have been completed is read. By doing so, the pen-shaped scanner a1n reads the codes to obtain the order information.

Images (not shown), such as photographs for various menu items, are also printed on the menu M1n.

FIG. 7 is a schematic view showing an example of the exchange coupon T1n according to the present embodiment.

In FIG. 7, calling number “50” is printed in an area T101 surrounded by a dotted line on the exchange coupon T1n. A calling number bar code is printed in an area T102 surrounded by a dotted line like the area T101. FIG. 7 shows a customer order printed on the exchange coupon T1n, in which “Cheeseburger” and “Cola” are ordered as items names by “2” and printed on the exchange coupon T1n. Further, since a total amount of money for the ordered items is also printed, the customer can prepare money for settlement in advance.

FIG. 8 is a schematic diagram showing an example of the menu file according to the present exemplary embodiment.

A master file for the menu file is stored in the server f1. The server f1 transmits a copy of the menu file to the pen-shaped scanner a1n via the register c1 and the printer/cradle b1n (see FIG. 1). The register c1, the printer/cradle b1n, and the pen-shaped scanner a1n store the received menu file therein.

As shown in FIG. 8, the menu file has items such as a menu item code, an item name, and price, and stores menu information for all items. For example, menu information corresponding to menu item code “102” indicates that the items name is “Cheeseburger” and the price thereof is “170” Yen.

FIG. 9 is a schematic diagram showing an example of the order file according to the present embodiment.

A master file for the order file is stored in the server f1. The server f1 transmits a copy of the order file to the pen-shaped scanner a1n via the register c1 and the printer/cradle b1n (see FIG. 1). The register c1, the printer/cradle b1n, and the pen-shaped scanner a1n store the received order file therein.

As shown in FIG. 9, the order file has items such as a calling number that is an identification number for an order, a menu item code indicating ordered items, the ordered number for items having the menu item code, the state of the order, and an input device ID for identifying the pen-shaped scanner, and stores order information for each calling number. Further, the order state has values such as “New” indicating that an order is received, “Cooking” indicating that the employee has printed a cooking instruction check using the register c1 to initiate cooking, and “Settlement completion” indicating that the employee has performed a items settlement process using the register c1 when delivering the cooked items. For example, in FIG. 9, order information corresponding to calling number “50” indicates that “two” items having a menu item code of “102” and “two” items having menu item code “201” are ordered by an input from the pen-shaped scanner all having input device ID “1” and each state is “Cooking.”

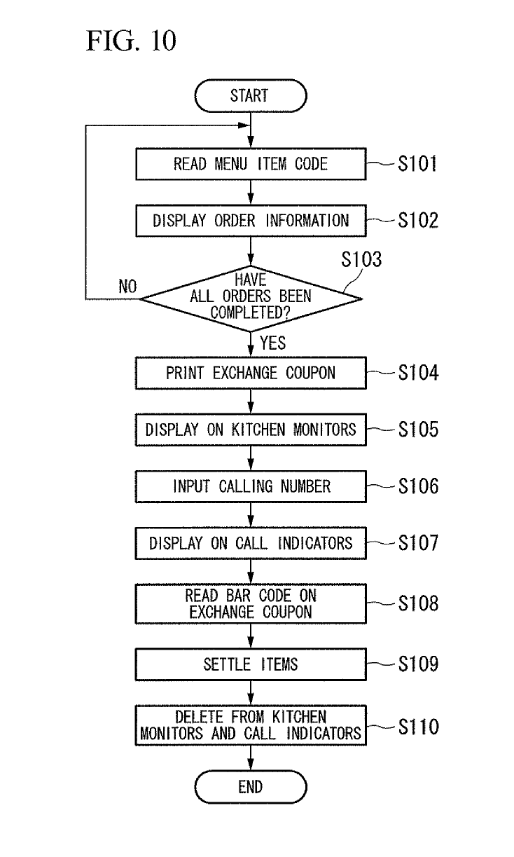

FIG. 10 is a flowchart showing an operation of an order management system according to the present embodiment.

(Step S101) A customer in a store walks to the order input set S1M (M is one of 1 to N) that is not used, and takes the pen-shaped scanner a1M from the printer/cradle b1M. The customer scans the areas of the menu M1n (areas M101, M102, or M111 to M115 in FIG. 6) in which chosen items names, numerals, or function names are recorded. The pen-shaped scanner a1M reads the codes printed on the areas. Each time the pen-shaped scanner a1M reads the codes, the pen-shaped scanner a1M transmits read information including the read codes, an input device ID (e.g., “M”) and a calling number to the register c1 through wireless communication. Here, the pen-shaped scanner a1M transmits a calling number output by the server f1 as the calling number in the read information. The pen-shaped scanner a1M resets the calling number after all orders have been completed (when it is determined as “Yes” in step S103). When the pen-shaped scanner a1M first reads a code after resetting the calling number, the pen-shaped scanner a1M transmits a null value indicating that there is no value as the calling number of the read information. The register c1 transmits the received read information to the server f1 via a LAN.

When the server f1 receives the read information from the register c1 and the calling number in the read information is a null value, the server f1 newly outputs a calling number. The output calling number is, for example, a number next to the greatest calling number among calling numbers of the order file. The server f1 sets a range of the output calling number to 1 to 100, and when the greatest calling number is “100,” the server f1 outputs “1” as a next number. When a calling number is newly output, the server f1 adds order information including the output calling number and the read information. Meanwhile, when the calling number in the read information is not null, the server f1 adds the read information to the order information corresponding to the calling number. The process then proceeds to step S102.

(Step S102) The server f1 transmits the order information additionally including the read information to the printer/cradle b1M in the order input set to which the pen-shaped scanner a1M indicated by the input device ID in the order information belongs, in step S102. The printer/cradle b1M displays the order information received from the server f1. For example, the printer/cradle b1M converts the menu item code in the order information into an items name based on a stored menu file, and displays the goods name and an ordered number. The process then proceeds to step S103.

(Step S103) The server f1 determines whether the code in the read information received in step S101 is the all-order completion code. If it is determined that the code is the all-order completion code, the process proceeds to step S104. Meanwhile, when it is determined that the code is not the all-order completion code, the process returns to step S101.

(Step S104) The server f1 retrieves the order information corresponding to the calling number in the read information used for the determination in step S103, and updates the state value of the retrieved order information to “New.” Next, the server f1 generates information for a calling number bar code obtained by coding the calling number corresponding to the order information. The server f1 transmits the order information having the updated state and the generated the calling number bar code information to the printer/cradle b1M. The printer/cradle b1M prints and issues an exchange coupon T1n based on the received information. The customer receives the issued exchange coupon T1n. The process then proceeds to step S105.

(Step S105) The server f1 transmits the order information corresponding to the calling number in the read information used for the determination in step S103 to the kitchen monitors e11 and e12 and the register c1. The kitchen monitors e11 and e12 display cooking instruction information based on the received order information. For example, the calling number corresponding to the order information, the items name, the ordered number, and the state are included in the cooking instruction information. When the register c1 receives an instruction to issue a cooking instruction check as the employee presses the button, the register c1 prints and issues the cooking instruction check based on the stored received order information. The cooking instruction check is a check on which the cooking instruction information is printed. When a settlement process for cooked items is terminated, the employee presses a button of the register c1 to cause the register c1 to issue a cooking instruction check in order to start cooking the next item. The employee starts cooking and setting the items indicated on the cooking instruction check. The register c1 transmits cooking initiation information indicating that the cooking instruction check has been issued, to the server f1. The calling number corresponding to the order information used for printing the cooking instruction check is included in the cooking initiation information. The server f1 retrieves the order information corresponding to the calling number included in the received cooking initiation information from the order file and updates the state value of the retrieved order information to “Cooking.” The server f1 transmits the order information having the updated state to the kitchen monitors e11 and e12, which update the state of the cooking instruction information corresponding to the received order information into “Cooking” and display the updated state. The process then proceeds to step S106.

(Step S106) When the items indicated on the cooking instruction check issued in step S105 have been cooked and set, the employee inputs the calling number of the cooking instruction check to the register c1. The process then proceeds to step S107.

(Step S107) The register c1 transmits the calling number input in step S106 to the call indicators d11 and d12 via the server f1. The call indicators d11 and d12 indicate the received calling number. The process then proceeds to step S108.

(Step S108) When viewing the calling number indicated by the call indicators d11 and d12 in step S107, the customer delivers the exchange coupon T1n issued in step S104 to the employee near the register c1. The employee reads the bar code printed on the received exchange coupon T1n using the bar code reader of the register c1. The register c1 transmits an order information request including the calling number read from the bar code to the server f1. The server f1 reads the order information corresponding to the calling number included in the received order information request from the order file. The server f1 transmits an order information response including the read order information to the register c1. The register c1 calculates and displays a total money amount for the ordered items based on the order information included in the received order information response and the previously stored menu file. Specifically, the register c1 reads the price corresponding to the menu item code from the menu file for all items indicated by the order information, and multiplies the read price by the ordered number in the order information to calculate the amount. The register c1 sums the calculated amounts for all the items. The process then proceeds to step S109.

(Step S109) When the employee key-inputs a money amount received from the customer to the register c1 and presses a settlement key, the register c1 performs a settlement process to calculate and display a change, and issues a receipt. The employee delivers the items, the displayed change, and the receipt to the customer and terminates the settlement for the items. That is, the register c1 performs the settlement process based on the exchange coupon T1n when the items indicated by the order information are delivered. The process then proceeds to step S110.

(Step S110) The register c1 transmits settlement termination information including the calling number corresponding to the order information that has been through to the settlement process in step S109 to the server f1. The server f1 retrieves the order information corresponding to the calling number included in the received settlement termination information from the order file, and updates the state value of the retrieved order information to “Settlement completion.” Further, the server f1 transmits display deletion information including the calling number included in the received settlement termination information to the call indicators d11 and d12 and the kitchen monitors e11 and e12. The call indicators d11 and d12 delete the display of the calling number included in the display deletion information. The kitchen monitors e11 and e12 delete the display of cooking instruction information corresponding to the calling number included in the display deletion information. The process then terminates the operation.

The order management system as in the present embodiment includes the plurality of order input sets Sn each consisting of the menu M1n, the pen-shaped scanner a1n, and the printer/cradle b1n. The order management system receives the order information as the customer operates the order input set (self order type), and issues the exchange coupon T1n to the customer. The order management system performs the settlement process based on the exchange coupon T1n using the register c1 when the items indicated by the order information are delivered. Accordingly, it is possible to decrease an order waiting time and shorten a waiting line by increasing the number of the order input sets Sn rather than the employees or the expensive registers c1 and to increase the number of order inputs that can be received. Specifically, the customer chooses items to be ordered while viewing the menu, which makes the time required for selection (order waiting time) longer than the time required for settlement. As in the present embodiment, the order input process (order input set Sn) and the settlement process (register c1) are separated, the order input process taking longer than the settlement process can improve a processing capability by increasing the number of the order input sets Sn, and the settlement process taking less time than the order input process is performed by the register c1. Thus, an order waiting time can be decreased, a waiting line can be shorter, and the number of order inputs that can be received can be increased.

According to the embodiment, since the pen-shaped scanner a1n has a simple configuration to read the codes from the menu M1n and obtain the order information, the pen-shaped scanner does not have keys or drawers and can be manufactured at low cost, unlike a conventional input device such as a register. Further, since the pen-shaped scanner a1n has the simple configuration, the pen-shaped scanner a1n can have a small size, and can be easily moved and used, unlike a conventional input device.

According to the embodiment, when the pen-shaped scanner a1n reads the all-order completion code from the menu M1n, the printer/cradle b1n issues the exchange coupon T1n. This eliminates a need for a key to instruct to issue the exchange coupon T1n in the pen-shaped scanner a1n or the printer/cradle b1n. Also, since the menu item codes and the order completion code are recorded on the menu M1n, an operation can be easily performed, unlike a case in which items designation keys and an order completion key are separated in different devices.

According to the embodiment, the order input sets Sn are disposed on the counter K1 between the kitchen area and the customer area. Accordingly, the distance between a customer operating the pen-shaped scanner a1n and the employee is shorter. As a result, the customer can freely ask the employee for assistance, and even when the customer does not know how to operate or erroneously inputs an order, unnecessary trouble, such as order cancellation after cooking completion, can be prevented.

In the exemplary embodiment, the pen-shaped scanner a1n performs wireless communication, but may perform wired communication. Also, the pen-shaped scanner a1n may have a function of the printer/cradle b1n. Accordingly, the configuration of the order management system can be simplified.

In the embodiment, the printer/cradle b1n may not include the display unit b105. For example, the printer/cradle b1n may print the order information using the printing unit b106. For example, the pen-shaped scanner a1n may sound-output the order information.

In the embodiment, the number of the order input sets Sn or the register c1 may be determined according to the number of customers visiting a store or a situation of the store.

In the embodiment, the menu may have a plurality of pages. Further, the codes recorded on the menu M1n may be, for example, bar codes.

The pen-shaped scanner a1n may have a function of controlling the display unit a105 of the printer/cradle b1n. For example, the pen-shaped scanner a1n may have a function of scrolling and displaying an items list displayed on the display unit a105. Also, a function code to scroll and display the items list may be recorded on the menu M1n, and the pen-shaped scanner a1n may read the function code to scroll and display the items list displayed on the display unit a105. Accordingly, even when the number of items in the order information is large and the items list cannot be entirely displayed on the display unit a105, the items list can be entirely confirmed through scrolling.

In the embodiment, an exchange coupon (T1n) issue code instructing to issue the exchange coupon T1n may be recorded on the menu M1n in place of the all-order completion code. That is, the issue code may serve as the all-order completion code.

In the embodiment, the register c1 issues the cooking instruction check, but the present invention is not limited thereto. For example, the order management system may further include a printer device for issuing the cooking instruction check. Also, the kitchen monitor may be of a touch panel type and when a displayed new order is touched, the state may be changed into cooking.

In the embodiment, the cooking instruction check may not be issued. When a new calling number is displayed on the kitchen monitors e11 and e12, the employee may announce “I am responsible for calling number ‘****’ (the displayed calling number).” Alternatively, cards numbered from 1 to 100 may be prepared in the kitchen, and the employee may take the smallest number among the calling numbers displayed on the kitchen monitors e11 and e12, be responsible for cooking ordered items, and return the card to the original position when the settlement process for the cooked items is terminated.

In the embodiment, some of the pen-shaped scanners a11 to a1N, the printer/cradles b11 to b1N, the register c1, the call indicators d11 and d12, the kitchen monitors e11 and e12, and the server f1 may be realized by a computer. For example, a program for realizing a control function may be recorded on a computer-readable recording medium, and may be read and executed by the computer system. Further, the “computer system” is a computer system embedded in the pen-shaped scanners a11 to a1N, the printer/cradles b11 to b1N, the register c1, the call indicators d11 and d12, the kitchen monitors e11 and e12, or the server f1, and includes an operating system (OS) or hardware such as peripheral devices. The “computer-readable recording medium” includes a storage unit, including a portable medium such as a flexible disk, a magnetic optical disk, a ROM, or a CD-ROM, and a hard disk embedded in the computer system. Further, the “computer-readable recording medium” may include a medium for temporarily and dynamically storing programs, like a communication line when a program is transmitted via a network such as the Internet or a communication line such as a telephone line, and a medium for storing programs for a predetermined time, like a volatile memory inside a computer system consisting of a server and a client in that case. The program may be a program for realizing some of the above-described functions. Alternatively, the program may be a program capable of realizing the above-described functions through a combination with a program previously stored in a computer system.

In the embodiment, the printer/cradle b1n of the order input set Sn can be rotated 180° so that an employee can input an order using one of the sets. Accordingly, the order input set Sn is suitable for customers who cannot easily perform an input operation.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An ordering method capable of receiving an input of order information for items and performing a settlement process when the items indicated by the order information that have been cooked are delivered, the ordering method comprising:
an order input step of reading codes indicating items from a menu to obtain the order information, the menu having a plurality of codes indicating items recorded thereon;
an exchange coupon printing step of issuing an exchange coupon, the exchange coupon having identification information for the order information obtained in the order input step printed thereon; and
a settlement processing step of performing the settlement process based on the exchange coupon when the items indicated by the order information have been delivered,
wherein a plurality of sets of order input units and exchange coupon printing units are disposed adjacent to one another for performing the order input step and the exchange coupon printing step.

2. An order management system for receiving an input of order information for items and performing a settlement process when the items indicated by the order information that have been cooked are delivered, the system comprising:
an order input unit for reading codes indicating items from a menu to obtain the order information, the menu having a plurality of codes indicating items recorded thereon;
an exchange coupon printing unit for issuing an exchange coupon having identification information printed thereon, the identification information identifying the order information obtained by the order input unit; and
a settlement processor for performing the settlement process based on the exchange coupon when the items indicated by the order information are delivered,
wherein a plurality of sets of the order input unit and the exchange coupon printing unit are disposed adjacent to one another toward customers.

3. The order management system according to claim 2, wherein an order completion code indicating that all orders have been completed is recorded on the menu, and
when the order input unit reads the order completion code from the menu, the exchange coupon printing unit issues the exchange coupon.

4. The order management system according to claim 2, wherein a counter is provided between a kitchen area where an employee cooks items and a customer area, a plurality of sets of the order input unit and the exchange coupon printing unit are disposed on the counter, and the customer inputs the order information using the order input unit.
